(19) United States
(12) Patent Application Publication
(10) Pub. No.: US 2009/0167031 A1
(43) Pub. Date: Jul. 2, 2009

(54) Electrical Energy Generator Based On Buoyancy

(76) Inventor: Roy Llewellyn, Cheshire (GB)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/922,764

(22) PCT Filed: Jun. 22, 2006
(86) PCT No.: PCT/GB2006/002262

§ 371 Date: Dec. 20, 2007

(30) Foreign Application Priority Data
Jun. 23, 2005 (GB) 0512800.4

(51) Int. Cl. H02K 7/18; H02J 7/00

(52) U.S. Cl. 290/1 R; 320/108

(57) ABSTRACT

This invention relates to an apparatus and method for generating electrical energy in a body of water. The apparatus and method relates to the effective conversion and storage of electrical energy which is analogous to a pumped storage system for generating electricity with hydroelectric power. The present invention includes an elongate stator assembly which, in use, is immersed in a body of water and having a plurality of electrical induction coils located thereon. The elongate stator assembly being secured in a substantially vertical position in the body of water using a base unit which is fixed to a seabed or the bottom of the body of water; the upper part of the elongate stator assembly being secured to a floatation buoy. The present invention also comprises a movable shuttle means which is coaxially coupled to the elongate stator assembly. The movable shuttle means having a plurality of permanent magnets disposed therein such that a magnetic flux is generated by the plurality of permanent magnets which intersects with the plurality of electrical induction coils located on the elongate stator assembly. The moveable shuttle means also includes buoyancy control means for cyclically controlling the depth of the movable shuttle means in the body of water such that the movement of the movable shuttle means relative to the elongate stator assembly induces a voltage in the plurality of electrical induction coils. The present invention also describes a method of operating an electrical energy generator in which, during the hours of low power consumption, electrical energy is taken from the power supply to charge the buoyancy control means and, during the hours of peak power consumption, the depth of the movable shuttle means is cyclically controlled and the voltage induced in the plurality of induction coils is extracted and converted and supplied to the power grid. In use, a plurality of electrical energy generators can be linked together to provide a significant energy-dense source.

This invention relates to an apparatus and method for generating electrical energy in a body of water. Said apparatus and method relates to the effective conversion and storage of electrical energy which is analogous to a pumped storage system for generating electricity with hydroelectric power.

It is well known that the energy requirements for the world are increasing year-upon-year, whereas the available usable energy is a finite resource. While there are still large supplies of coal, oil and natural gas, the amount of new supplies being found is decreasing. This has led to increased development of renewable energy sources such as wind, solar, thermal, tidal and wave energy. Each of these techniques suffers from various advantages and disadvantages, and despite many years of development, not one of these techniques has proven to be particularly popular or dominant, as only around 5% of the world's energy comes from renewable sources.

One example of a wave energy to electrical energy power conversion apparatus is set forth in WO 01/06119, which comprises a buoy having a coil which acts as the armature of a generator. A voltage is induced when waves cause coils located inside the buoy to move relative to the magnetic field of an anchored shaft. Clearly, the problem associated with this approach, and all sea wave electrical conversion apparatuses, is that a relative motion is required to move the buoy, e.g. if the surface of the sea is calm, there is no relative movement and no electrical energy is generated. Therefore, such a wave energy conversion apparatus has to be located in a position where there are waves produced of a defined height and frequency to give an appropriate electrical output. Generally speaking, such wave energy conversion apparatuses have to be located near to the coastline, which of course has various environmental and ecological concerns.

It is the object of the present invention to provide an apparatus and method for generating electrical energy in a body of water. It is the inherent buoyancy of the body of water, coupled with gravity, which is used to generate electrical energy, and not any surface effects. As such, the present invention can be used in any sufficiently deep body of water, i.e. in the sea or even in inland lakes or reservoirs, and is operated completely under the surface of the water. The present invention operates in a similar manner to pumped storage systems whereby overnight, when demand is not so great, electrical energy can be taken from the power grid to recharge a moveable shuttle having permanent magnets disposed therein. During the hours of peak power consumption on the power grid, the buoyancy of the movable shuttle is cyclically controlled such that the movement of the movable shuttle relative to a plurality of electrical induction coils mounted on a fixed stator assembly induces a voltage which is then made available to the power grid.

According to the present invention there is provided an electrical energy generator suitable for use in a body of water, comprising:

an elongate stator assembly which, in use, is immersed in said body of water and having a plurality of electrical induction coils located therein, said elongate stator assembly being secured in a substantially vertical position in said body of water; and

a movable shuttle means being coaxially coupled to said elongate stator assembly, said movable shuttle means having a plurality of permanent magnets disposed therein such that a magnetic flux is generated by said plurality of permanent magnets which intersects with said plurality of electrical induction coils located in said elongate stator assembly, said movable shuttle means also having buoyancy control means for cyclically controlling the depth of said movable shuttle means in said body of water such that the movement of said movable shuttle means relative to said elongate stator assembly induces a voltage in said plurality of electrical induction coils.

Preferably, said elongate stator assembly comprises a plurality of sectionalised iron cores disposed in a cruciform configuration. In use, the gaps or spaces between said plurality of sectionalised iron cores and said plurality of electrical induction coils are filled with a suitable buoyant material. Preferably, each of said plurality of sectionalised iron cores has an electrical induction coil wound thereon. Further preferably, the ends of each said electrical induction coil can be series or parallel connected and taken to a shore station via a power cable.

In a preferred embodiment, one end of the elongate stator assembly is fixedly secured to a seabed or the bottom of said body of water using a base unit, and the other end is connected to a buoy or other floatation means or any structure capable of holding the elongate stator assembly in a substantially vertical position.

Further preferably, said movable shuttle means is coaxially coupled to said elongate stator assembly via a central aperture. In use, said movable shuttle means is free to move in both a linear motion, i.e. upwardly and downwardly, and rotatably around said elongate stator assembly. Said movable shuttle means may be of cylindrical form and includes at least one pair of propeller screws.

Preferably, in use, said plurality of permanent magnets are arranged on a carousel and which rotates said plurality of permanent magnets in a circular motion about their own axes. In a further embodiment, said plurality of permanent magnets are arranged sequentially in an annular configuration around the inner periphery of said movable shuttle means. Said plurality of permanent magnets can be implemented using any suitable permanent magnetic material, such as, for example, Neodymium Iron Boron (NdFeB), Samarium Cobalt (SmCo), Alnico or other ceramics, ferrites or rare earth materials.

In a preferred embodiment, said base unit has an internal structure which meets with the bottom of said movable shuttle means when it is parked in the base unit. In order to prevent damage to said moveable shuttle means, a cushion may be provided which runs around the inner periphery of said base unit. In use, said base unit also provides the electrical connection between said plurality of electrical induction coils on said elongate stator assembly and said power cable, which may also be used to recharge said buoyancy control means for controlling the depth of said movable shuttle means.

Further preferably, said power cable is also used to power said buoyancy control means for controlling the depth of the movable shuttle means, via an induction charger transmitter which meets with an appropriate induction band receiver in said moveable shuttle means. In use, the power taken from the power cable may be used to recharge batteries via a charging coil to power a geared motor and pump assembly.

In use, the buoyancy of the moveable shuttle means may be controlled using said geared motor and pump assembly. To float the movable shuttle means once it has reached said base unit is achieved when a sensor loop in said base unit actuates said geared motor and pump assembly which forces hydraulic fluid from a chamber to an external flexible bladder, which, in use, is annular-shaped. Pumping of hydraulic fluid into said flexible bladder causes the buoyancy of said moveable shuttle means to increase which then raises the moveable shuttle means towards the surface of the water. Preferably, the angle of said pair of propeller screws causes rotation of the moveable shuttle means and the linear and rotational movement of the magnetic flux generated by said plurality of permanent magnets induces a voltage in said plurality of electrical induction coils.

In use, a plurality of movable shuttle means may be coaxially coupled to said elongate stator assembly and which all operate independently.

Also according to the present invention there is provided a method of operating an electrical energy generator electrically connected to a power grid, said electrical energy generator comprising an elongate stator assembly immersed substantially vertically in a body of water, said elongate stator assembly having a plurality of electrical induction coils located therein, said electrical energy generator also comprising a movable shuttle means being coaxially coupled to said elongate stator assembly, said movable shuttle means having a plurality of permanent magnets disposed therein such that a magnetic flux is generated by said plurality of permanent magnets which intersects with said plurality of electrical induction coils located in said elongate stator assembly, and buoyancy control means for controlling the depth of said movable shuttle means in said body of water, the method comprising the steps of:

electrically charging said buoyancy control means during the hours of low power consumption on said power grid;

cyclically controlling the depth of said movable shuttle means in said body of water such that the movement of said movable shuttle means relative to said elongate stator assembly induces a voltage in said plurality of electrical induction coils during the hours of peak power consumption on said power grid; and

extracting and converting said voltage induced in said plurality of electrical induction coils to an appropriate voltage and frequency level for supply to said power grid.

Further according to the present invention there is provided an elongate stator for use with at least one movable rotor having a plurality of permanent magnets disposed therein such that a magnetic flux is generated by said plurality of permanent magnets, said elongate stator comprising a tubular outer section enclosing a plurality of sectionalised cores arranged in a substantially cruciform configuration along the length of said elongate stator, each of said plurality of sectionalised cores having an electrical induction coil wound thereon such that, in use, movement at said at least one movable rotor relative to the elongate stator induces a voltage in the respective one of said plurality of electrical induction coils.

It is believed that an apparatus and method for generating electrical energy in accordance with the present invention at least addresses the problems outlined above. The advantages of the present invention are that an apparatus and method are provided which utilise the inherent buoyancy of the body of water, coupled with gravity, to generate electrical energy, and not any surface effects. As such, the present invention can be used in any sufficiently deep body of water, i.e. in the sea or even in inland lakes or reservoirs, and is operated completely under the surface the water. Advantageously, the present invention operates in a similar manner to pumped storage systems whereby overnight, when demand is not so great, electrical energy can be taken from the power grid to recharge a moveable shuttle having permanent magnets disposed therein. During the hours of peak power consumption on the power grid, the buoyancy of the movable shuttle is cyclically controlled such that the movement of the movable shuttle relative to a plurality of electrical induction coils mounted on a fixed stator assembly induces a voltage which is then made available to the power grid.

It will be obvious to those skilled in the art that variations of the present invention are possible and it is intended that the present invention may be used other than as specifically described herein.

A specific non-limiting embodiment of the invention will now be described by way of example and with reference to the accompanying drawings, in which:

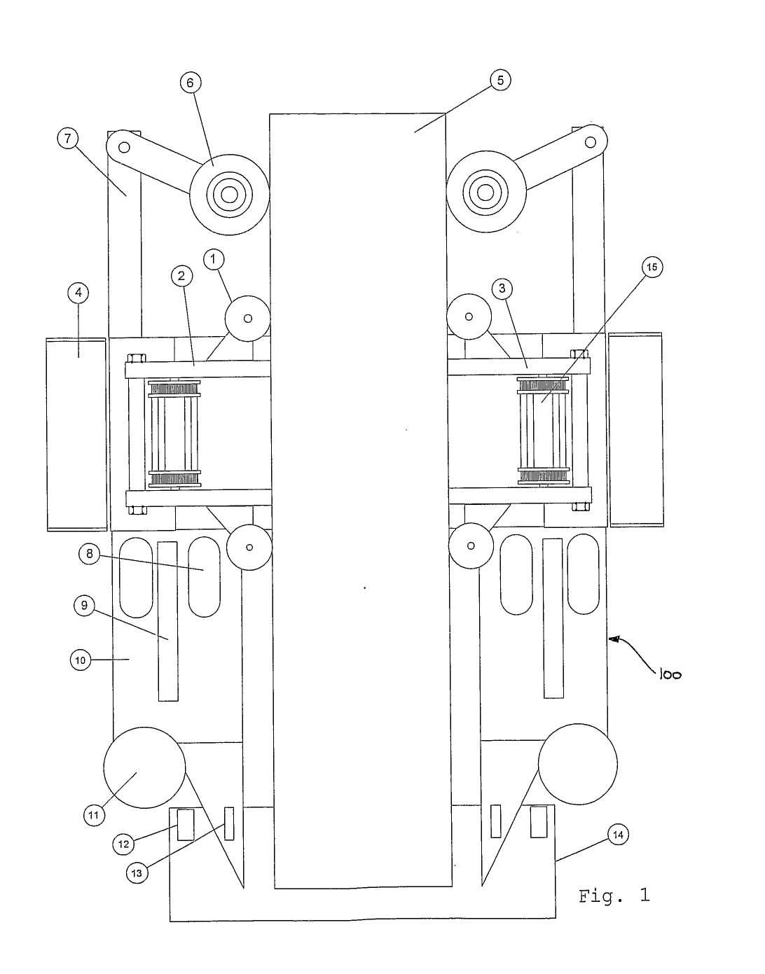

FIG. 1 shows a section of the side elevation of the present invention and shows detail of how the movable shuttle means is coupled to the elongate stator assembly and parked in a base unit;

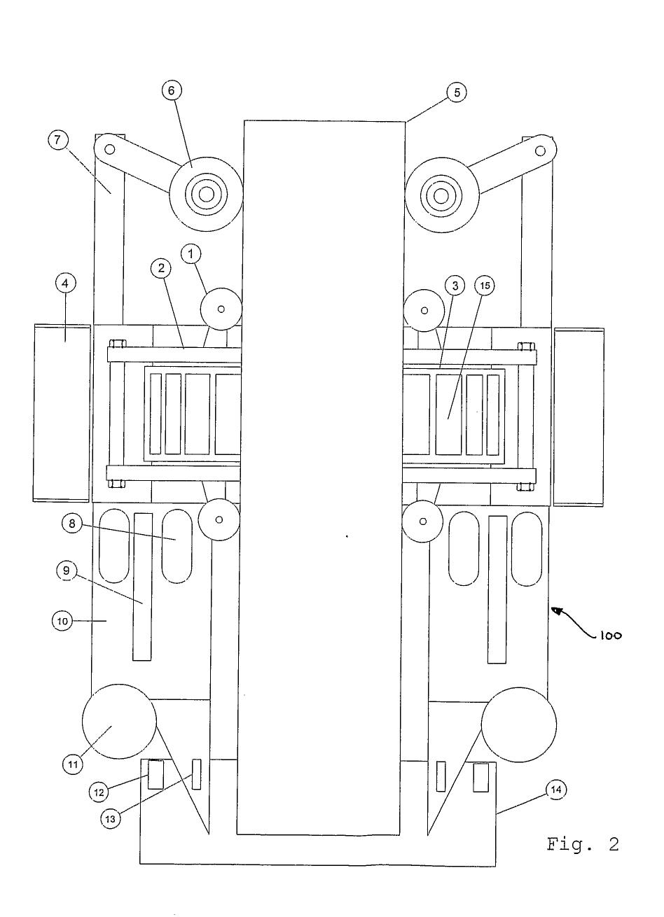

FIG. 2 illustrates a section of the side elevation of an alternative embodiment of the present invention wherein the high-power permanent magnets are arranged sequentially in an annular configuration inside a magnet housing around the inner periphery of the movable shuttle means;

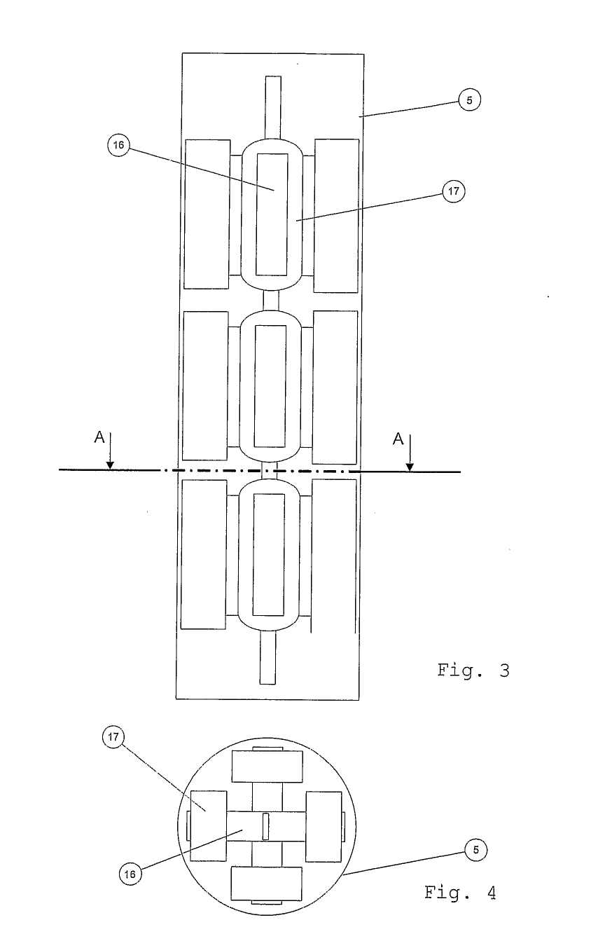

FIG. 3 is a section of the side elevation of the elongate stator assembly of the present invention;

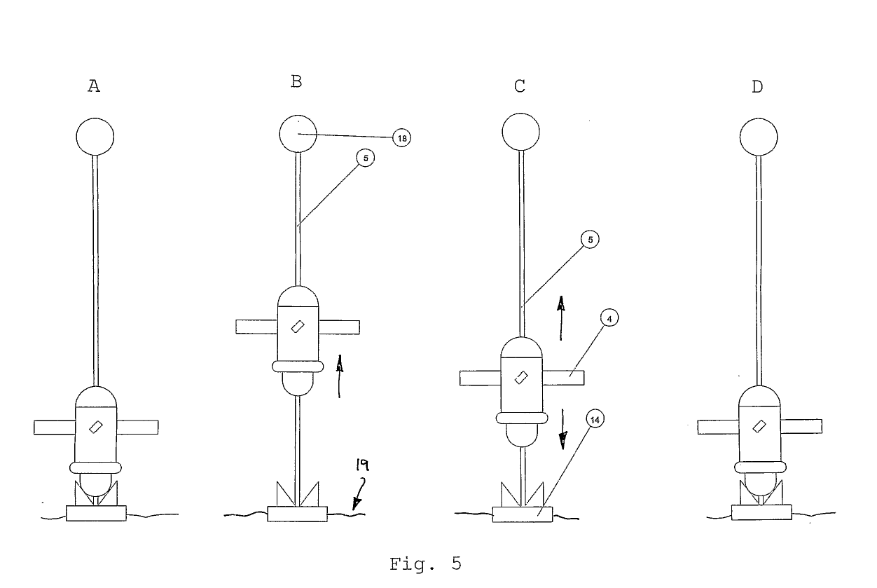

FIG. 4 shows a top sectional view of the elongate stator assembly along the line A-A′ in FIG. 3;

FIG. 5 shows schematically how the present invention can be operated to generate electrical energy; and

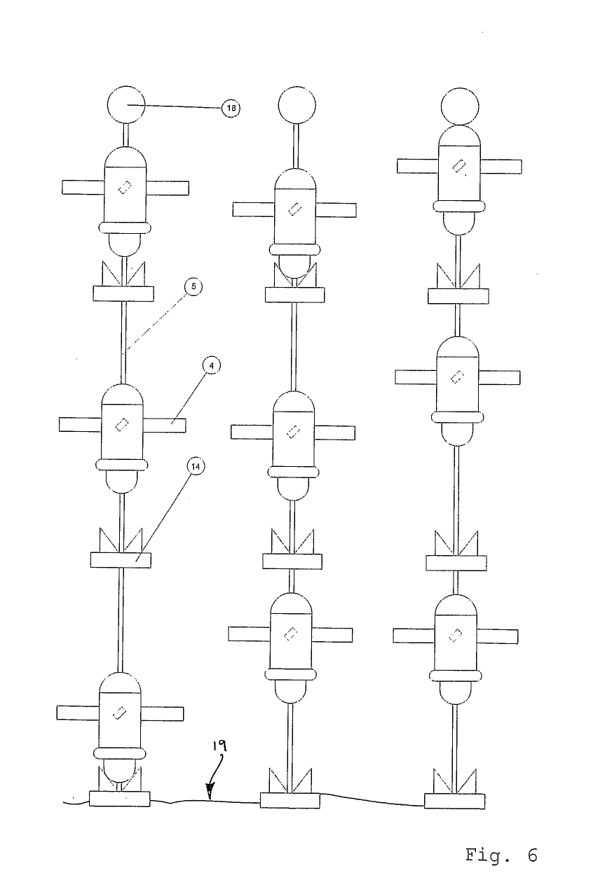

FIG. 6 shows how the present invention can be operated to provide a significant energy-dense source.

Referring now to the drawings, the implementation of the present invention is shown in FIGS. 1 to 6. In particular, FIGS. 1 and 2 show detail of the movable shuttle 100 of the present invention, which, in use, is coaxially coupled to an elongate stator assembly 5 via a central aperture. In use, the movable shuttle 100 is free to move both in a linear motion, i.e. upwardly and downwardly, and rotatably around the fixed elongate stator assembly 5. The movable shuttle 100 is of a substantially cylindrical form and includes a body housing 10 and at least one pair of propeller screws 4. In FIGS. 1 and 2, only the base of the propeller screws 4 are shown and it will be appreciated that the propeller screws 4 extend outwardly from the movable shuttle 100, as outlined in FIGS. 5 and 6. Although the present invention can be implemented without propeller screws 4 or more than one pair of propeller screws 4, the skilled person will appreciate that any number of techniques could be utilised to bring about rotational movement of the movable shuttle 100 in a body of water (not shown). As mentioned, the purpose of the pair of propeller screws 4 being to cause rotational movement of the movable shuttle 100 as it moves either upwardly or downwardly around the elongate stator assembly 5 in order to maximise the voltage induced in a plurality of electrical induction coils 17 which are located within the elongate stator assembly, as shown in more detail in FIGS. 3 and 4.

The movable shuttle 100 also includes a plurality of high-power permanent magnets 15 which are arranged in an annular configuration inside a magnet housing 3 around the inner periphery of the movable shuttle 100. The high-power permanent magnets 15 can be implemented using any suitable permanent magnetic material, such as, for example, Neodymium Iron Boron (NdFeB), Samarium Cobalt (SmCo), Alnico or other ceramics, ferrites or rare earth materials. It is the movement of the permanent magnets 15 mounted on the moveable shuttle 100 relative to the induction coils 17 located within the elongate stator assembly 5 which induces an electrical voltage.

FIG. 1 also shows how the elongate stator assembly 5 and movable shuttle 100 are situated in a base unit 14 which is fixed to a seabed or the bottom of a suitable body of water (not shown). The base unit 14 having an internal structure which meets with the bottom of the movable shuttle 100 when it is parked in the base unit 14. In order to prevent damage to the movable shuttle 100, a cushion (not shown) is provided which runs around the inner periphery of the base unit 14. The base unit 14 also provides the electrical connection between the induction coils 17 on the elongate stator assembly 5, via a power cable 19 (shown in FIGS. 5 and 6), which is also used to recharge a buoyancy control means for controlling the depth of the movable shuttle 100. The electrical output of the elongate stator assembly 5 is taken to a shore station (not shown) via the suitably armoured power cable 19, as shown in FIGS. 5 and 6, for signal conversion etc., prior to the generated electrical power being made available to the electrical grid (not shown).

In use, to generate electrical energy, the movable shuttle 100 descends down the elongate stator assembly 5, and a series of guide wheels 1 located around the inner periphery of the movable shuttle 100 contact the outer surface of the elongate stator assembly 5 to help it run smoothly. In addition, a series of drive wheels 6 located around the inner periphery of the movable shuttle 100 also turn. The drive wheels 6 are connected via a flexible drive (not shown) to a gearbox (not shown) which, in turn, is attached to the magnet carousel 3 containing the permanent magnets 15. As the carousel 3 spins, the magnetic flux generated by the plurality of permanent magnets 15 intersects with the plurality of induction coils 17 located in the elongate stator assembly 5, which causes electricity to flow. Changing the angle of the screw propellers 4 controls the speed of descent.

FIGS. 1 and 2 show two arrangements of the high-power permanent magnets 15 located within the movable shuttle 100. FIG. 1 shows one arrangement whereby the drive wheels 6, flexible drive (not shown) and gearbox (not shown) rotate the permanent magnets 15 in a circular motion about their own axes, i.e. the magnet carousal 3 is fixed and the permanent magnets 15 rotate. Alternatively, as shown in FIG. 2, a number of high-power permanent magnets 15 are arranged sequentially in an annular configuration around the inner periphery of the movable shuttle 100. The magnetic carousel 3 is then driven, via the drive wheels 6, such that the permanent magnets 15 are rotated around the elongate stator assembly 5, and hence induction coils 17, as it falls under the effect of gravity. Whichever specific method is employed, the skilled person will appreciate that it is the movement of the permanent magnets 15 located on the movable shuttle 100 relative to the induction coils 17 inside the fixed elongate stator assembly 5 that is important.

When the movable shuttle 30 reaches the base station 14, the buoyancy of the movable shuttle 100 is then altered such that it then floats towards the top of the elongate stator assembly 5 to start the generation process again. In use, the buoyancy of the movable shuttle 100 may be controlled using a geared motor and pump assembly 9. Floating the movable shuttle 100 once it has reached the bottom of the seabed is achieved when a sensor loop (not shown) in the base unit 14 actuates the geared motor and pump assembly 9. This forces hydraulic fluid from an internal chamber (not shown) to an external flexible bladder 11, which is annular shaped. Pumping of hydraulic fluid into the flexible bladder 11 causes the buoyancy of the movable shuttle 100 to increase, which then raises the movable shuttle 100 towards the surface of the water. In doing so, the angle of the propeller screws 4 causes the rotation of the movable shuttle 100 and the rotational movement of magnetic flux generated by the plurality of permanent magnets 15 induces a voltage in the plurality of electrical induction coils 17 located in the elongate stator assembly 5.

Alternatively, it may not be desired to produce electrical energy when the movable shuttle 100 ascends, and in these circumstances, the drive wheels 6 can be automatically lifted clear above the surface of the elongate stator assembly 5 thereby disconnecting the drive to the magnet carousel 3 containing the permanent magnets 1, and the movable shuttle 100 simply allowed to float to the surface. Of course, in do so, the linear movement of the permanent magnets 15 relative to the elongate stator assembly 5 is still sufficient to induce a voltage in the plurality of electrical induction coils 17.

The power cable 19 through the base unit 14 is also used to power the buoyancy control means for controlling the depth of the movable shuttle 100, via an induction charger transmitter 12 which meets with an appropriate induction band receiver 13 in the movable shuttle 100. The power taken from the power cable 19 is used to recharge batteries 8 to power the geared motor and pump assembly 9.

FIGS. 3 and 4 show detail of the elongate stator assembly 5, which, in use, is secured to a seabed or the bottom of a suitable body of water (not shown). The elongate stator assembly 5 is of a tubular form and comprises a plurality of sectionalised iron cores 16, each having a plurality of electrical induction coils 17 wound thereon. In use, it is envisaged that the gaps or spaces between the iron cores 16 and induction coils 17 are filled with a suitable buoyant material (not shown). As is shown in FIG. 4, the sectionalised iron cores 16 are disposed in a cruciform configuration inside elongate stator assembly 5, thereby ensuring that the distance between the induction coils 17 wound on the iron cores 16, and the magnetic flux produced by permanent magnets 15 arranged around the inner periphery of the movable shuttle 100 is minimised as far as possible. The cruciform configuration also ensures that the induction coils 17 can be wound with the maximum number of turns to maximise the induced voltage according to Faraday's laws of induction.

In use, each of the sectionalised iron cores 16 in the elongate stator assembly 5 has a corresponding induction coil 17 wound thereon; the ends of the induction coils 17 can be series or power connected and taken to a shore station (not shown) via a suitably armored power cable 19. To ensure that the elongate stator assembly 5 containing the plurality of induction coils 17 is secured in a substantially vertical position in the water, one end of the elongate stator assembly 5 is fixedly secured to the seabed or the bottom of a suitable body of water (not shown) and the other end is connected to a buoy 18, as shown in FIGS. 5 and 6, or other flotation means or any structure capable of holding the elongate stator assembly 5 in a substantially vertical position.

Clearly, the other benefits of using sectionalised iron cores 16 and induction coils 17 wholly contained within the elongate stator assembly 5 is that a structure is produced that is able to resist exposure to potentially substantial tidal and wave energies, and also provides a smooth and uniform circumference ensuring that the movable shuttle 100 is free to move both in a linear motion, i.e. upwardly and downwardly, and rotatably around the fixed elongate stator assembly 5.

It is envisaged that the present invention will operate in a similar manner to pumped storage systems whereby overnight, when demand is not so great, electrical energy can be taken from the power grid to recharge the batteries 8 for the buoyancy control means on the movable shuttle 100. During the hours of peak power consumption on the power grid, the buoyancy of the movable shuttle 100 is cyclically controlled such that the movement of said movable shuttle 100 relative to the elongate stator assembly 5 induces a voltage in the plurality of electrical induction coils 17 which is then made available to the power grid.

FIG. 5 shows further detail of the method of operating the electrical energy generator of the present invention, as described above. In particular, FIG. 5 shows four separate stages of operation, namely A to D. In the first stage, namely stage A, the movable shuttle 100 is parked in the base unit 14 and electrical power is taken from power cable 19 to charge the buoyancy control means which controls the buoyancy of the movable shuttle 100. In the second stage, namely stage B, as instructed by an appropriate signal through the power cable 19, hydraulic oil in the internal chamber is expelled to the external flexible bladder 11, causing the movable shuttle 100 to float towards the surface. In doing so, the relative movement of the moveable shuttle 100 in relation to the elongate stator assembly 5 induces a voltage in the induction coils 17. The propeller screws 4 on the moveable shuttle 100 ensure that the movable shuttle 100 rotates as it rises to maximise the voltage induced in the plurality of electrical induction coils 17.

As shown in stage C, when the shuttle 100 reaches the uppermost section of the elongate stator assembly 5, the hydraulic oil is returned to the chamber, which allows the moveable shuttle 100 to fall and spin, again generating electricity as it does so. Throughout the day, the moveable shuttle 100 is raised and allowed to fall in a continuous cycle until batteries 8 in the moveable shuttle 100 are run down. As shown at stage D, which is the same as stage A, the movable shuttle 100 is then parked in the base unit 14 and electrical power is taken from power cable 19 to recharge the buoyancy control means overnight.

FIG. 6 shows schematically how many of the electrical energy generating apparatuses of the present invention can be grouped together to provide a significant energy-dense source. In use, with the moveable shuttles 100 operating at different cycle stages, a large quasi-continuous power source is produced which evens out the peaks and troughs observed in the operation cycle of a single electrical energy generator. In deep bodies of water, as is outlined in FIG. 6, it is envisaged that a number of moveable shuttles 100 and base units 14 could be stacked on each elongate stator assembly 5, and which all operate independently.

Various alterations or modifications may be made to the present invention without departing from the scope of the invention.

1. An electrical energy generator suitable for use in a body of water, comprising:
an elongate stator assembly which, in use, is immersed in said body of water and having a plurality of electrical induction coils located therein, said elongate stator assembly being secured in a substantially vertical position in said body of water; and
a movable shuttle means being coaxially coupled to said elongate stator assembly, said movable shuttle means having a plurality of permanent magnets disposed therein such that a magnetic flux is generated by said plurality of permanent magnets which intersects with said plurality of electrical induction coils located in said elongate stator assembly, said movable shuttle means also having buoyancy control means for cyclically controlling the depth of said movable shuttle means in said body of water such that the movement of said movable shuttle means relative to said elongate stator assembly induces a voltage in said plurality of electrical induction coils.

2. An electrical energy generator as claimed in claim 1, wherein said elongate stator assembly comprises a plurality of sectionalised iron cores disposed in a cruciform configuration.

3. An electrical energy generator as claimed in claim 2, wherein the gaps or spaces between said plurality of sectionalised iron cores and said plurality of electrical induction coils are filled with a suitable buoyant material.

4. An electrical energy generator as claimed in claims 2 or 3, wherein each of said plurality of sectionalised iron cores has an electrical induction coil wound thereon.

5. An electrical energy generator as claimed in claim 4, wherein the ends of each of said electrical induction coil are series or parallel connected and taken to a shore station via a power cable.

6. An electrical energy generator as claimed in claim 1, wherein one end of the elongate stator assembly is fixedly secured to the bottom of said body of water using a base unit, and the other end is connected to a buoy or other floatation means or any structure capable of securing the elongate stator assembly in a substantially vertical position.

7. An electrical energy generator as claimed in claim 1, wherein said movable shuttle means is coaxially coupled to said elongate stator assembly via a central aperture.

8. An electrical energy generator as claimed in claims 1 or 7, wherein said movable shuttle means is free to move in both a linear motion and rotatably around said elongate stator assembly.

9. An electrical energy generator as claimed in any of claims 1, 7 or 8, wherein said movable shuttle means is of substantially circular form and includes at least one pair of propeller screws.

10. An electrical energy generator as claimed in claim 1, wherein said plurality of permanent magnets are arranged on a carousel and which rotates said plurality of permanent magnets in a circular motion about their own axes.

11. An electrical energy generator as claimed in claim 1, wherein said plurality of permanent magnets are arranged sequentially in an annular configuration around the inner periphery of said movable shuttle means.

12. An electrical energy generator as claimed in claims 1 or 11, wherein said plurality of permanent magnets can be implemented using any suitable permanent magnetic material, such as, Neodymium Iron Boron (NdFeB), Samarium Cobalt (SmCo), Alnico or other ceramics, ferrites or rare earth materials.

13. An electrical energy generator as claimed in claim 6, wherein said base unit has an internal structure adapted to meet with the bottom of said movable shuttle means when it is parked in said base unit.

14. An electrical energy generator as claimed in claims 6 or 13, wherein said base unit comprises a cushion which runs around the inner periphery of said base unit.

15. An electrical energy generator as claimed in any of claims 6, 13 or 14, wherein said base unit provides electrical connection between said plurality of electrical induction coils on said elongate stator assembly and said power cable.

16. An electrical energy generator as claimed in claim 15, wherein said power cable is also used to power said buoyancy control means for controlling the depth of the movable shuttle means, via an induction charger transmitter which meets with an appropriate induction band receiver in said moveable shuttle means.

17. An electrical energy generator as claimed in claim 16, wherein said power cable is used to recharge batteries, via a charging coil, to power said buoyancy control means in said moveable shuttle means.

18. An electrical energy generator as claimed in claim 1, wherein said buoyancy control means comprises a geared motor and pump assembly capable of pumping hydraulic fluid from a chamber to an external flexible bladder.

19. An electrical energy generator as claimed in claim 18, wherein said external flexible bladder is substantially annular-shaped.

20. An electrical energy generator as claimed in claim 1, wherein a plurality of movable shuttle means are coaxially coupled to said elongate stator assembly and which all operate independently.

21. A method of operating an electrical energy generator electrically connected to a power grid, said electrical energy generator comprising an elongate stator assembly immersed substantially vertically in a body of water, said elongate stator assembly having a plurality of electrical induction coils located therein, said electrical energy generator also comprising a movable shuttle means being coaxially coupled to said elongate stator assembly, said movable shuttle means having a plurality of permanent magnets disposed therein such that a magnetic flux is generated by said plurality of permanent magnets which intersects with said plurality of electrical induction coils located in said elongate stator assembly, and buoyancy control means for controlling the depth of said movable shuttle means in said body of water, the method comprising the steps of:
electrically charging said buoyancy control means during the hours of low power consumption on said power grid;
cyclically controlling the depth of said movable shuttle means in said body of water such that the movement of said movable shuttle means relative to said elongate stator assembly induces a voltage in said plurality of electrical induction coils during the hours of peak power consumption on said power grid; and
extracting and converting said voltage induced in said plurality of electrical induction coils to an appropriate voltage and frequency level for supply to said power grid.

22. A method as claimed in claim 20, wherein the step of cyclically controlling the depth of said movable shuttle means further comprises the step of detecting when said movable shuttle means has reached the bottom of said body of water and actuating a geared motor and pump assembly which forces hydraulic fluid from a chamber to an external flexible bladder to increase the buoyancy of said movable shuttle means.

23. An elongate stator for use with at least one movable rotor having a plurality of permanent magnets disposed therein such that a magnetic flux is generated by said plurality of permanent magnets, said elongate stator comprising a tubular outer section enclosing a plurality of sectionalised cores arranged in a substantially cruciform configuration along the length of said elongate stator, each of said plurality of sectionalised cores having an electrical induction coil wound thereon such that, in use, movement at said at least one movable rotor relative to the elongate stator induces a voltage in the respective one of said plurality of electrical induction coils.

24. An electrical energy generator as hereinbefore described with reference to FIGS. 1 to 6 of the accompanying drawings.

25. A method of operating an electrical energy generator as hereinbefore described.

26. An elongate stator for use with at least one movable rotor as hereinbefore described with reference to FIGS. 1 to 6 of the accompanying drawings.
